(19) United States
(12) Patent Application Publication
(10) Pub. No.: US 2006/0218173 A1
(43) Pub. Date: Sep. 28, 2006

(54) Method, system, and program product for invention mining

(75) Inventors: Scott D. Hicks, Underhill Center, VT (US); James A. Martin JR., Endicott, NY (US); Douglas G. Murray, Johnson City, NY (US); Jeffrey E. Prince, Bloomfield Hills, MI (US); Diane C. Rauch, Williston, VT (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/086,182

(22) Filed: Mar. 22, 2005

(51) Int. Cl. G06F 7/00

(52) U.S. Cl. 707/102

(57) ABSTRACT

The present invention provides a method, system, and computer program product for invention mining. The method includes: extracting and storing in a first database a predetermined, limited amount of information from all invention disclosures submitted by members of a project team; generating an invention disclosure report using information extracted from each of the invention disclosures; and displaying the invention disclosure report in a user interface (UI), wherein all members of the project team can access the displayed invention disclosure report.

### BACKGROUND OF THE INVENTION

1. Field of the Invention

The present invention generally relates to data mining systems. More particularly, the present invention provides a method, system, and computer program product for invention mining.

2. Related Art

A team working on a project may hold periodic “brainstorming” meetings in which inventive aspects of the project are “mined” to extract potentially patentable subject matter. Invention disclosures describing the potentially patentable subject matter are then generated and submitted to the project team's Intellectual Property (IP) department for review and possible further processing (e.g., patentability search, patent application, etc.). Unfortunately, the members of the project team often lose track of invention disclosures once they are submitted to the IP department. This may hinder the members of the project team in the mining of further inventions based on or related to previously submitted invention disclosures, may increase the time spent by members of the project team on administrative tracking tasks, may cause members of the project team to lose focus of the priority of the team's invention disclosures (i.e., “out of sight, out of mind”), and may adversely affect the submission of invention disclosures by the members of the project team in the future.

### SUMMARY OF THE INVENTION

In general, the present invention provides a method, system, and computer program product for invention mining. In particular, the present invention provides a tool for assisting a project team in creating, tracking, prioritizing, categorizing, and filing invention disclosures associated with the project team's invention mining efforts on one or more projects.

A first aspect of the present invention is directed to a method for invention mining, comprising: extracting and storing in a first database a predetermined, limited amount of information from all invention disclosures submitted by members of a project team; generating an invention disclosure report using information extracted from each of the invention disclosures; and displaying the invention disclosure report in a user interface (UI), wherein all members of the project team can access the displayed invention disclosure report.

A second aspect of the present invention is directed to a system for invention mining, comprising: a system for extracting and storing in a first database a predetermined, limited amount of information from all invention disclosures submitted by members of a project team; a system for generating an invention disclosure report using information extracted from each of the invention disclosures; and a system for displaying the invention disclosure report in a user interface (UI), wherein all members of the project team can access the displayed invention disclosure report.

A third aspect of the present invention is directed to a program product stored on a computer readable medium for invention mining, the computer readable medium comprising program code for performing the following steps: extracting and storing in a first database a predetermined, limited amount of information from all invention disclosures submitted by members of a project team; generating an invention disclosure report using information extracted from each of the invention disclosures; and displaying the invention disclosure report in a user interface (UI), wherein all members of the project team can access the displayed invention disclosure report.

A fourth aspect of the present invention is directed to a method for deploying an application for invention mining, comprising: providing a computer infrastructure being operable to: extract and store in a first database a predetermined, limited amount of information from all invention disclosures submitted by members of a project team; generate an invention disclosure report using information extracted from each of the invention disclosures; and display the invention disclosure report in a user interface (UI), wherein all members of the project team can access the displayed invention disclosure report.

A fifth aspect of the present invention is directed to computer software embodied in a propagated signal for invention mining, the computer software comprising instructions to cause a computer system to perform the following functions: extract and store in a first database a predetermined, limited amount of information from all invention disclosures submitted by members of a project team; generate an invention disclosure report using information extracted from each of the invention disclosures; and display the invention disclosure report in a user interface (UI), wherein all members of the project team can access the displayed invention disclosure report.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for invention mining in accordance with an embodiment of the present invention.

FIGS. 2-8 depict illustrative user interfaces (UIs) provided in accordance with an embodiment of the present invention.

FIG. 9 depicts a computer system for implementing an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for invention mining. In particular, the present invention provides a tool for assisting a project team in creating, tracking, prioritizing, categorizing, and filing invention disclosures associated with the project team's invention mining efforts on one or more projects. The present invention enables the project team to concentrate on invention mining efforts for particular project(s), provides an environment that enhances the inventive creativity of the project team, and reduces the time required by administrative tasks related to the tracking of invention disclosures.

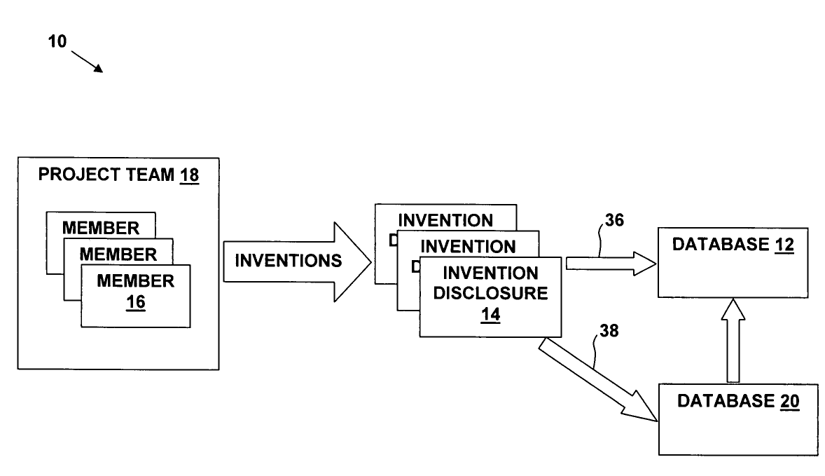

A system 10 for invention mining in accordance with an embodiment of the present invention is depicted in FIG. 1. System 10 includes a team disclosure database 12 for gathering limited information on all invention disclosures 14 submitted by members 16 of a project team 18. Such limited information can be entered into team disclosure database 12 by a member 16 of the project team 18, an administrator, or other authorized user, and/or can be imported into team disclosure database 12 from another source, such as from an another database 20. Any member 16 of the project team 18, as well as other authorized users, can access the information related to their project stored in the team disclosure database 12.

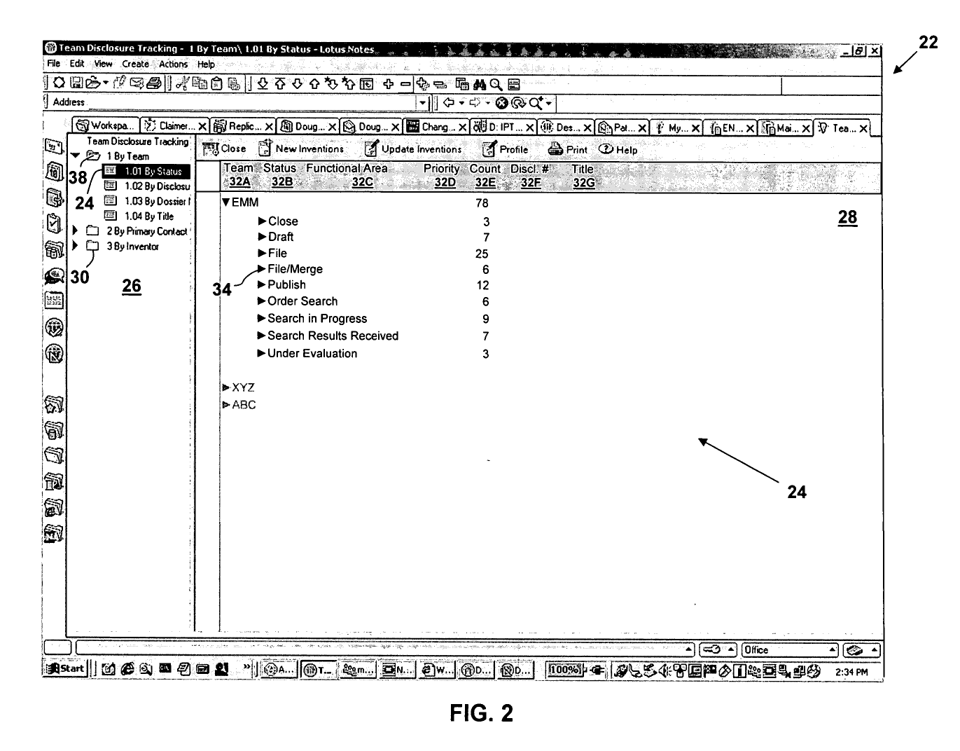

The team disclosure database 12 organizes and displays in a user interface (UI) 22 (FIG. 2) information regarding all invention disclosures 14 submitted by members 16 of project team 18. Information regarding invention disclosures 14 can be presented/organized in UI 22 in a number of different ways. For example, in the view shown in FIG. 2, UI 22 displays an invention disclosure report 24 in which invention disclosures 14 are categorized by “Team” and “Status.”

In the present example, UI 22 is organized into two panes: a report selection pane 26 and a data viewing pane 28. It will be apparent to those skilled in the art, however, that many different UI techniques can be used to organize/present/display data, reports, etc., in accordance with the present invention. Accordingly, the dual pane technique described herein is not intended to be limiting in any way.

As shown in FIG. 2, invention disclosure reports 24 are organized in the report selection pane 26 of UI 22 using at least one folder 30:
(A) “By Team”;
(B) “By Primary Contact”; and
(C) “By Inventor.”
   When an invention disclosure report 24 in one of the folders 30 is selected, for example, by a member 16 of the project team 18, it is displayed in the data viewing pane 28 of UI 22. It should be noted that folders 30 other than those displayed in FIG. 2 could be used to organize invention disclosure reports 24 in the report selection pane 26 of UI 22 in accordance with the present invention, and that the specific folders 30 described herein are not intended to be limiting in any way. Further, invention disclosure reports 24 could be organized within sub-folders (not shown) of folders 30, and so on, in a hierarchical manner.

As shown in FIG. 2, the invention disclosure reports 24 contained within the “By Team” folder 38 in this example comprise:
(A) 1.01 “By Status”;
(B) 1.02 “By Disclosure Number”;
(C) 1.03 “By Dossier Number”; and
(D) 1.04 “By Title.”
   Many other types of invention disclosure reports 24 could also be provided in accordance with the present invention, based on user needs and/or other factors.

In FIG. 2, a member 16 of the “EMM” project team 18 has selected the invention disclosure report 24 “By Status” located within the folder 30 “By Team.” In response, the selected invention disclosure report 24, organized according to “Team” and “Status,” is displayed within the data viewing pane 28 of UI 22. As shown, the selected invention disclosure report 24 is organized into a plurality of columns 32A-G including: “Team” 32A, “Status” 32B, “Functional Area” 32C, “Priority” 32D, “Count” 32E, “Discl. #” 32F, and “Title” 32G. It should be noted that the specific types, number, and arrangement of columns displayed in the data viewing pane 28 may be different for each invention disclosure report 24. It should also be noted that detailed information regarding each of the invention disclosures 14 is not displayed in UI 22.

The invention disclosures 14 listed in the selected invention disclosure report 24 are split up into the following status categories: “Close,” “Draft,” “File,” “File/Merge,” “Order Search,” “Publish,” “Search in Progress,” “Search Results Received,” and “Under Evaluation.” In this example, the status categories are listed in alphabetic order, although any desired ordering can be used.

It can be seen in the “Count” column 32E of the selected invention disclosure report 24 that the members 16 of the “EMM” project team 18 have submitted a total of 78 invention disclosures 14. Examining both the “Count” column 32E and the “Status” column 32B of the selected disclosure report 24, it can be seen that the status of the 78 invention disclosures in this example is split up as follows:
“Close”—3
“Draft”—7
“File”—25
“File/Merge—6
“Publish”—12
“Order Search”—6
“Search in Progress”—9
“Search Results Received”—7
“Under evaluation”—3
   Additional/different status categories can also be used in the practice of the present invention. For example, different organization may use different terminology to describe the various stages of the invention process, and may use other status categories not listed above.

The above-listed status categories in this example can be defined, for example, as follows:
(A) “Close”—Close invention disclosure (e.g., not patentable);
(B) “Draft”—Invention disclosure is currently being drafted (e.g., by inventor(s));
(C) “File”Invention disclosure to be filed as a patent application;
(D) “File/Merge”—A plurality of invention disclosures are to be combined and filed as a single patent application;
(E) “Publish”—Invention disclosure to be published (e.g., in a Technical Journal);
(F) “Order Search”—Order patentability search;
(G) “Search in Progress”—Awaiting results of patentability search;
(H) “Search Results Received”—Search results received and under review; and
(I) “Under Evaluation”—Invention disclosure being evaluated to determine status (e.g., close, search, file, etc.).

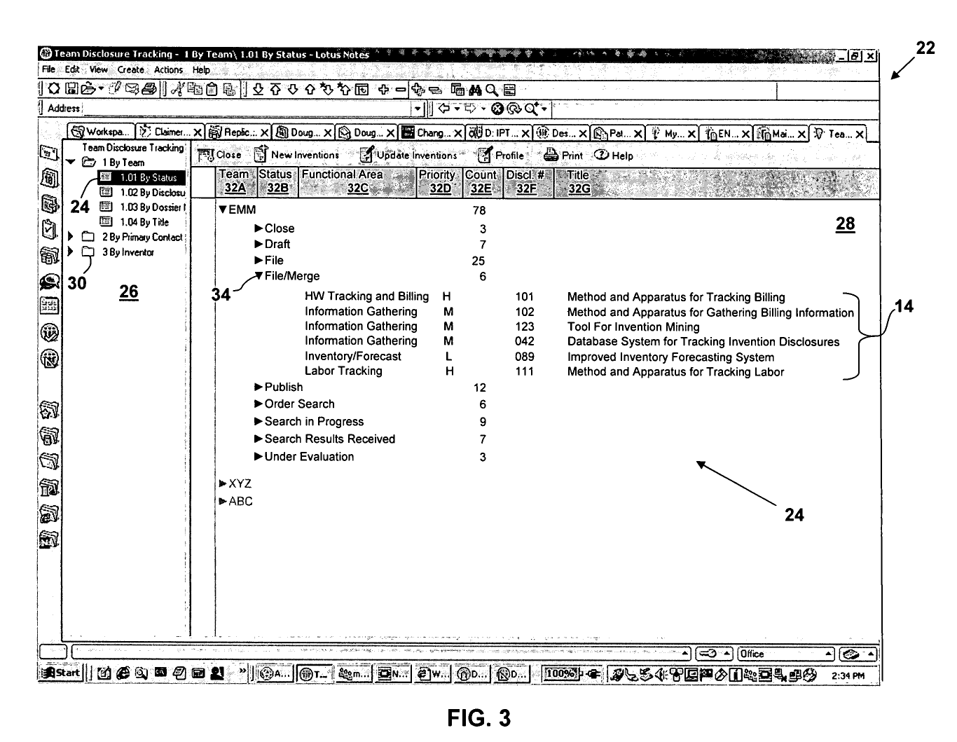

When the entry for “File/Merge” in the “Status” column 32B is expanded, the selected invention disclosure report 24 appears as depicted in FIG. 3. An entry in the selected invention disclosure report 24 displayed in the data viewing pane 28 of UI 22 can be expanded/contracted in a known manner via a drop-down arrow 34 or other suitable technique. After selection of the entry for “File/Merge,” the selected invention disclosure report 24 now displays a limited amount of predetermined information regarding the invention disclosure(s) 14 having a “File/Merge” status. In the present example, the functional area, priority (e.g., High (H), Medium (M), Low (L)), invention disclosure number, and title are displayed in respective columns of the selected invention disclosure report 24. The “Functional Area” column 32C provides a free-form description used to group inventions within a project. The “Priority” column 32D is set (e.g., by the project team 18) as “H,” “M,” or “L” based on, for example, the net worth and/or patentability of the invention. This aids in the setting of the order in which inventions are be searched, filed, etc. The “Count” column 32E provides a current count of invention disclosures for each team and status. Finally, the disclosure number and title of an invention disclosure 14 is provided in the “Discl. #” column 32F and “Title” column 32G, respectively. Selection of other entries in the “Status” column 32B will display information associated with the invention disclosures 14 having the selected status in a similar manner.

It should be noted that the team disclosure database 12 of the present invention is not intended to be used to provide members 16 of a project team 18 with access to the invention disclosures 14 themselves. Rather, it is used to provide all members 16 of a project team 18, including those members 16 of a project team 18 who are not an inventor on some or all of the submitted invention disclosures 14, with limited information regarding all of the invention disclosures related to the project. This provides a place where the members 16 of the project team 18 can mine their ideas from ongoing projects and keep track of the status of all invention disclosures associated with the projects through the invention process.

In the system 10 of FIG. 1, limited information regarding invention disclosures 14 is provided to the team disclosure database 12 as indicated by arrow 36, while the invention disclosures 14 themselves are submitted to database 20 as indicated by directional arrow 38. Access to invention disclosure information in the team disclosure database 12 for a project is generally limited to the members 16 of that project team 18, while access to an invention disclosure in database 20 is generally limited to the inventors on, or creator of, that invention disclosure. Referring again to FIG. 2, for example, it can be seen that a members 16 of the project team 18 “EMM” do not have access to invention disclosure information associated with other project teams 18 “XYZ” and “ABC” (grayed out to indicate no access).

Links can be provided in UI 22 to allow a member 16 of the project team 18, who is also an inventor on a listed invention disclosure 14, to access the complete invention disclosure 14 in database 20. Security measures such as username/password could be used to limit access to the invention disclosures 14 in database 20.

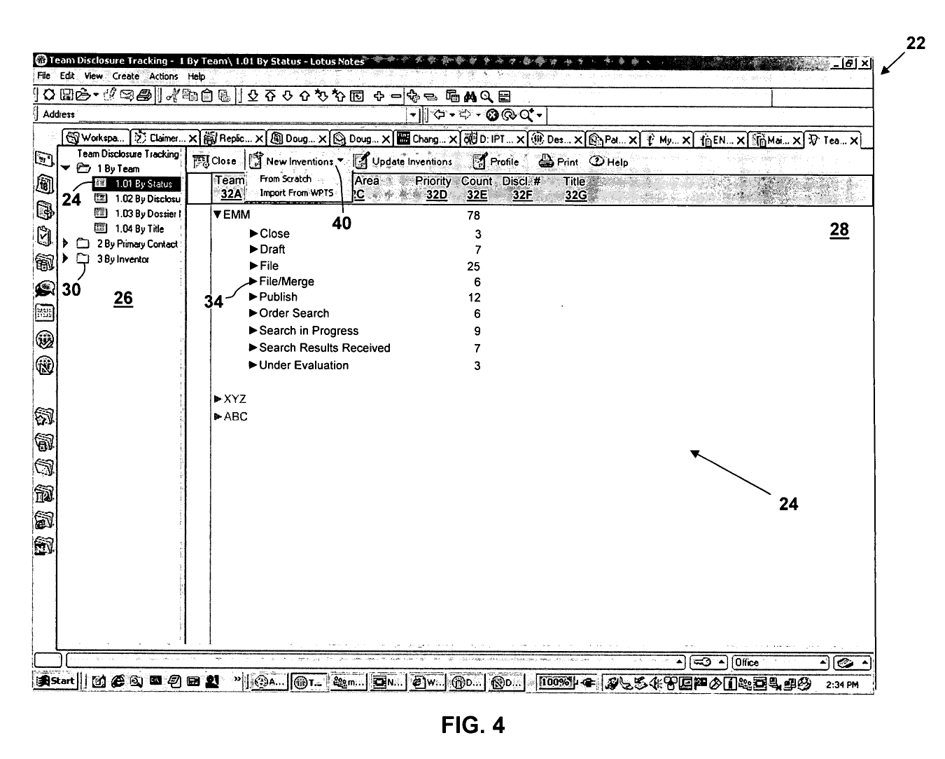

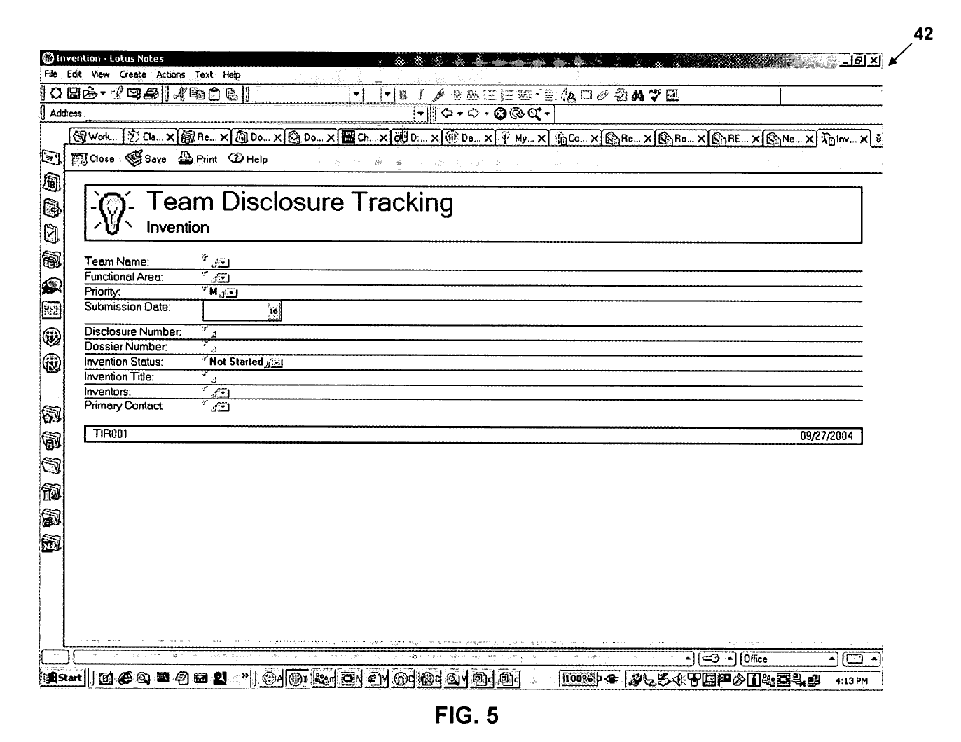

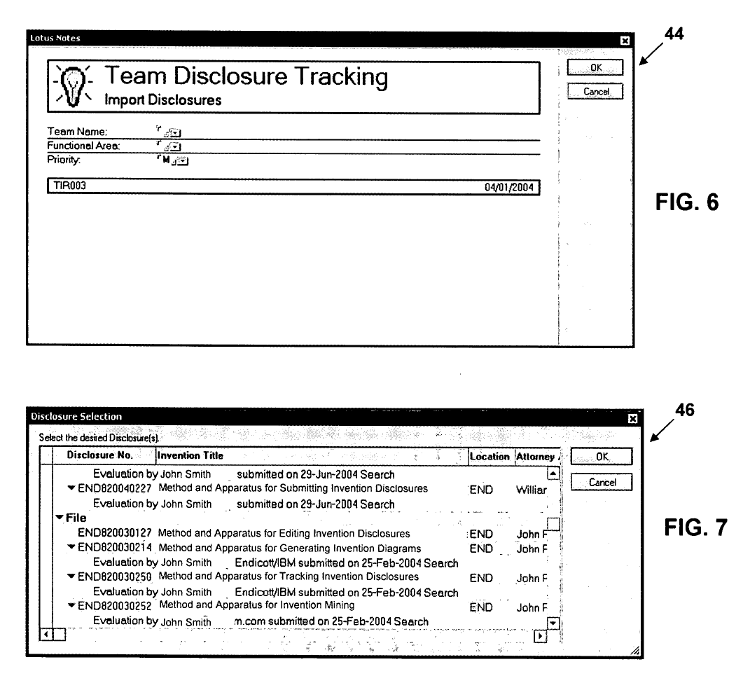

As shown in FIG. 4, information regarding a new invention disclosure 14 can be input into the team disclosure database 12 upon selection of the “New Inventions” button 40 in UI 22. Information regarding a new invention disclosure 14 can be provided “From Scratch” or can be imported from another source such as database 20 (named “WPTS” in this example). Selection of “From Scratch” opens up a UI 42 as shown in FIG. 5, into which limited information regarding a new invention disclosure 14 can be entered. Selection of “From WPTS” opens up a UI 44 as shown in FIG. 6. Information such as the name of a project team 18 can be entered into UI 44 to pull up a UI 46 (FIG. 7) that provides a listing of invention disclosures 14 associated with a specific project team 18. An invention disclosure 14 can then be selected via UI 46, and information corresponding thereto imported into the team disclosure database 12.

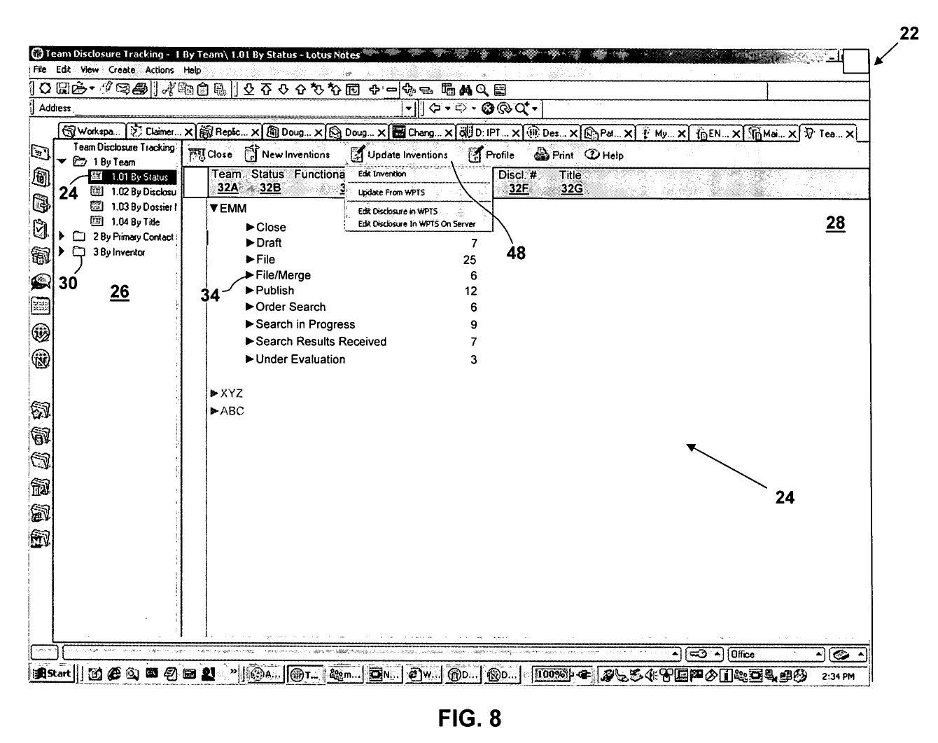

As shown in FIG. 8, information regarding an existing invention disclosure 14 can be edited upon selection of the “Update Inventions” button 48 in UI 22. For example, information in the team disclosure database 12 corresponding to a selected invention disclosure 14 can be edited directly in UI 22 (or other suitable UI) after selecting “Edit Invention” or updated information can be imported from database 20 by selecting “Update From WPTS.” Information regarding an invention disclosure 14 can also be edited in database 20, for example, by selecting “Edit Disclosure in WPTS” and subsequently imported into the team disclosure database 12. Other editing techniques are also possible.

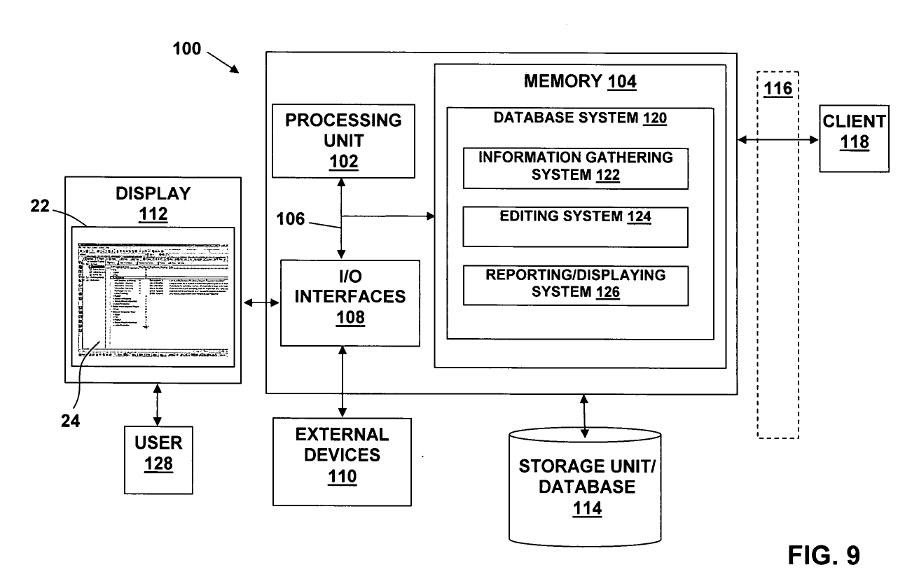

A computer system 100 for implementing an embodiment of the present invention is illustrated in FIG. 9. Computer system 100 generally includes a processing unit 102, memory 104, bus 106, input/output (I/O) interface(s) 108, and external devices/resource(s) 110. Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms.

I/O interface(s) 108 may comprise any system for exchanging information to/from an external source. External devices/resource(s) 110 may comprise any known type of external device, including speakers, a CRT, LED screen, handheld device, keyboard, mouse, voice recognition system, speech output system, printer, monitor/display (e.g., display 112), facsimile, pager, etc.

Bus 106 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Data (e.g., information on all invention disclosures 14 submitted by members 16 of a project team 18, invention disclosure reports 24, etc.) used in the practice of the present invention can be stored locally to computer system 100, for example, in storage unit/database 114 (e.g., as team disclosure database 12), and/or may be provided to computer system 100 over a network 116. Storage unit/database 114 can be any system capable of providing storage for data and information under the present invention. As such, storage unit/database 114 may reside at a single physical location, comprising one or more types of data storage, or may be distributed across a plurality of physical systems in various forms. In another embodiment, storage unit/database 114 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. One or more client devices 118 may be connected to computer system 100 via network 116. Each client device 118 comprises components similar to those described above with regard to computer system 100.

Shown in memory 104 as a computer program product is a database system 120. Database system 120 includes an information gathering system 122 for gathering/importing limited information on all invention disclosures 14 submitted by members 16 of a project team 18, an editing system 124 for updating/editing such information, and a reporting/displaying system 126 for generating/displaying invention disclosure reports 24 and other information to a user 128 (e.g., a member 16 of a project team 18) in accordance with the present invention. The reporting/displaying system 126 provides a user interface 22 for displaying the invention disclosure reports 24 as detailed above.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to provide invention mining, as described above.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A method for invention mining, comprising:
extracting and storing in a first database a predetermined, limited amount of information from all invention disclosures submitted by members of a project team;
generating an invention disclosure report using information extracted from each of the invention disclosures; and
displaying the invention disclosure report in a user interface (UI), wherein all members of the project team can access the displayed invention disclosure report.

2. The method of claim 1, further comprising:
tracking, in the invention disclosure report, a status of all invention disclosures submitted by the members of the project team.

3. The method of claim 2, wherein the status indicates where each respective invention disclosure currently is in an invention process.

4. The method of claim 2, further comprising:
organizing the invention disclosure report according to the status of each invention disclosure.

5. The method of claim 4, further comprising:
providing, in the invention disclosure report, a count of a number of invention disclosures at each status.

6. The method of claim 1, further comprising:
providing, in the invention disclosure report, a count of a total number of invention disclosures submitted by the members of the project team.

7. The method of claim 1, further comprising:
setting, in the invention disclosure report, a priority for each invention disclosure submitted by the members of the project team.

8. The method of claim 1, wherein the predetermined, limited amount of information comprises a title of each invention disclosure submitted by the members of the project team.

9. The method of claim 8, wherein the predetermined, limited amount of information further comprises an identifier for each invention disclosure submitted by the members of the project team.

10. The method of claim 1, further comprising:
storing detailed information for each invention disclosure in a second database; and
importing the predetermined, limited amount of information into the first database from the detailed information stored in the second database.

11. The method of claim 10, wherein access to the detailed information for each invention disclosure in the second database is limited to an inventor of the invention disclosure.

12. Deploying an application for invention mining, comprising:
providing a computer infrastructure being operable to perform the method of claim 1.

13. Computer software embodied in a propagated signal for invention mining, the computer software comprising instructions to cause a computer system to perform the method of claim 1.

14. A system for invention mining, comprising:
a system for extracting and storing in a first database a predetermined, limited amount of information from all invention disclosures submitted by members of a project team;
a system for generating an invention disclosure report using information extracted from each of the invention disclosures; and
a system for displaying the invention disclosure report in a user interface (UI), wherein all members of the project team can access the displayed invention disclosure report.

15. The system of claim 14, further comprising:
a system for tracking, in the invention disclosure report, a status of all invention disclosures submitted by the members of the project team.

16. The system of claim 15, wherein the status indicates where each respective invention disclosure currently is in an invention process.

17. The system of claim 15, further comprising:
a system for organizing the invention disclosure report according to the status of each invention disclosure.

18. The system of claim 17, further comprising:
a system for providing, in the invention disclosure report, a count of a number of invention disclosures at each status.

19. The system of claim 14, further comprising:
a system for providing, in the invention disclosure report, a count of a total number of invention disclosures submitted by the members of the project team.

20. The system of claim 14, further comprising:
a system for setting, in the invention disclosure report, a priority for each invention disclosure submitted by the members of the project team.

21. The system of claim 14, wherein the predetermined, limited amount of information comprises a title of each invention disclosure submitted by the members of the project team.

22. The system of claim 21, wherein the predetermined, limited amount of information further comprises an identifier for each invention disclosure submitted by the members of the project team.

23. The system of claim 14, further comprising:
a system for storing detailed information for each invention disclosure in a second database; and
a system for importing the predetermined, limited amount of information into the first database from the detailed information stored in the second database.

24. The system of claim 23, wherein access to the detailed information for each invention disclosure in the second database is limited to an inventor of the invention disclosure.

25. A program product stored on a computer readable medium for invention mining, the computer readable medium comprising program code for performing the following steps:
extracting and storing in a first database a predetermined, limited amount of information from all invention disclosures submitted by members of a project team;
generating an invention disclosure report using information extracted from each of the invention disclosures; and
displaying the invention disclosure report in a user interface (UI), wherein all members of the project team can access the displayed invention disclosure report.
